(19) United States
(12) Patent Application Publication
(10) Pub. No.: US 2006/0023463 A1
(43) Pub. Date: Feb. 2, 2006

(54) Reading lamp for a vehicle

(75) Inventors: Guido Bigge, Sundern (DE); Oliver Haacke, Lippstadt (DE); Rico Schulz, Lippstadt (DE)

Correspondence Address: BIRCH STEWART KOLASCH & BIRCH, PO BOX 747, FALLS CHURCH, VA, 22040-0747, US

(73) Assignee: Goodrich Hella Aerospace Lighting Systems GmbH, Lippstadt (DE)

(21) Appl. No.: 11/177,310

(22) Filed: Jul. 11, 2005

Related U.S. Application Data
(60) Provisional application No. 60/589,002, filed on Jul. 20, 2004.

(30) Foreign Application Priority Data
Jul. 12, 2004 (EP) 04 016 339.6

(51) Int. Cl. B60R 1/12

(52) U.S. Cl. 362/494

(57) ABSTRACT

A reading light for a vehicle, in particular for fitting above a vehicle seat of a vehicle, such as an airplane, comprises at least one LED emitting white light, and a reflector and/or a light cover, the reflector and/or the light cover being provided with a coating that absorbs or reduces the intensity of the light of the at least one LED whose wavelength is less than a predefinable wavelength value.

### BACKGROUND OF THE INVENTION

1. Field of the Invention

The invention refers to a reading light for a vehicle and in particular to a reading light adapted to be mounted above the passenger seats of a vehicle. Such a vehicle may be, for example, a coach and in particular an airplane.

2. Related Prior Art

Vehicle reading lights generally comprise halogen lamps that emit “warm” light and are therefore perceived as being comfortable. Among other reasons, his perception is also based on the sensitivity of the human eye, since the human eye is sensitive in the wavelength range from about 380 nm to 780 nm.

LEDs are employed ever more often as light sources in vehicles. Especially, since LEDs emitting white light have become available in recent years, an even stronger trend to apply LEDs in vehicles can be observed.

In contrast to halogen lamps, LEDs have a relatively strong emission in particular in the short-wave wavelength range (about 380 nm to about 510 nm). Since, as mentioned above, the human eye is also sensitive in that range, the white light of an LED is perceived as being “cold”.

To generate “warm” light with LED technology, LEDs emitting in a relatively narrow range were sought for, i.e. LEDs which do not emit light in the “cold” wavelength range. Thus, until now, the problem of “cold radiation” of LEDs was encountered by using LEDs emitting outside this wavelength range.

EP 1 190 903 A2 describes an airplane reading light with filter function that is restricted to ambient light that has no influence on the target area to be illuminated. The initially emitted light is manipulated by transmission through the filter. The change of the color of light is not effected by a reflector in the true sense of the word. Both functions, i.e. reflection/transmission of light and filtering/manipulation of the color of light, are physically separated. Further, not all of the emitted light is manipulated. It is merely a small part of the total light flux of the LED that is changed by the filter.

US 2003/0133292 A1 describes an additive color mixing of RGB LEDs. Thus, it is observed what effect is caused by mixing different colors of light from light sources emitting in narrow wavebands. In the instance of mixing red, green and blue, white light is obtained.

U.S. Pat. No. 5,353,210 basically describes a cold light reflector lamp. The light source is a discharge lamp and, besides reflecting visible light, the reflector is intended to not reflect the invisible part of light. In particular, the coating is meant to reflect the hazardous UV part of the generated light and not to reflect it on the target area to be illuminated.

US 2001/0000622 A1 describes the generation of white light by a semiconductor that emits blue light and the additive mixing of colors with a conversion material generating yellow light. The original blue emission is an emission in a spectrally narrow band. The yellow light generated by the conversion material has a very broad spectral band. Adding both results in white light.

In U.S. Pat. No. 6,132,072, similar to US 2003/0133292 A1, white light color is generated by additive color mixing of at least two colors of light. Basically, this conventional light also is a RGB light. The design of the light allows for an active and prompt manipulation of the color of light by changing the electrical marginal conditions. The reflector included in this design is of secondary importance.

U.S. Pat. No. 4,042,818 describes an incandescent lamp as a light source. In this case, the color of light is manipulated by transmission. The transmitted light is deflected to the target area by the reflector. Thus, there is a functional separation between the deflection of light and the manipulation of color. Moreover, no particular coating of the reflector is mentioned that would have particular spectral properties.

It is an object of the invention to provide a reading light for a vehicle, whose light emission is perceived as being comfortable despite the use of a LED emitting white light.

### SUMMARY OF THE INVENTION

According to the invention, the object is solved with a reading light for a vehicle, in particular for fitting above a passenger seat of a vehicle, such as an airplane, the reading light being provided with
at least one LED emitting white light, and
a reflector and/or a light cover,
the reflector and/or the light cover being provided with a coating that absorbs or reduces the intensity of the light of the at least one LED whose wavelength is less than a predefinable wavelength value.

The present solution thus is to fade out or reduce the intensity of the “cold part” of the at least one LED of the reading light emitting white light. According to the invention, this is effected by a coating applied either on a reflector (if the reading light comprises a reflector) or on the light cover of the reading light. The coating may also be applied both on the light cover and the reflector, if present.

In the simplest case, the coating is a color coat application. However, it is also possible to use materials that, in terms of light physics, act such that they reduce the intensity of light of certain wavelength ranges, i.e. at least partly absorb that light. In this respect, a coating of copper or even gold, for example, is suitable.

The present reading light does not comply with the general trend in employing LEDs emitting white light in that, according to the invention, this white light is partly filtered out or absorbed. Preferably, the absorption/reduction of intensity is effected in a wavelength range of about 380 nm to about 510 nm, the LED preferably emitting in the wavelength range of about 380 nm to about 780 nm.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings in which

FIG. 1 a first embodiment of a reading light according to the present invention with a coated reflector,

FIG. 2 a second embodiment of the invention with a coated light cover, and

FIG. 3 intensity distributions for the LED used, the coating and the resulting emitted light.

### DESCRIPTION OF A PREFERRED EMBODIMENT

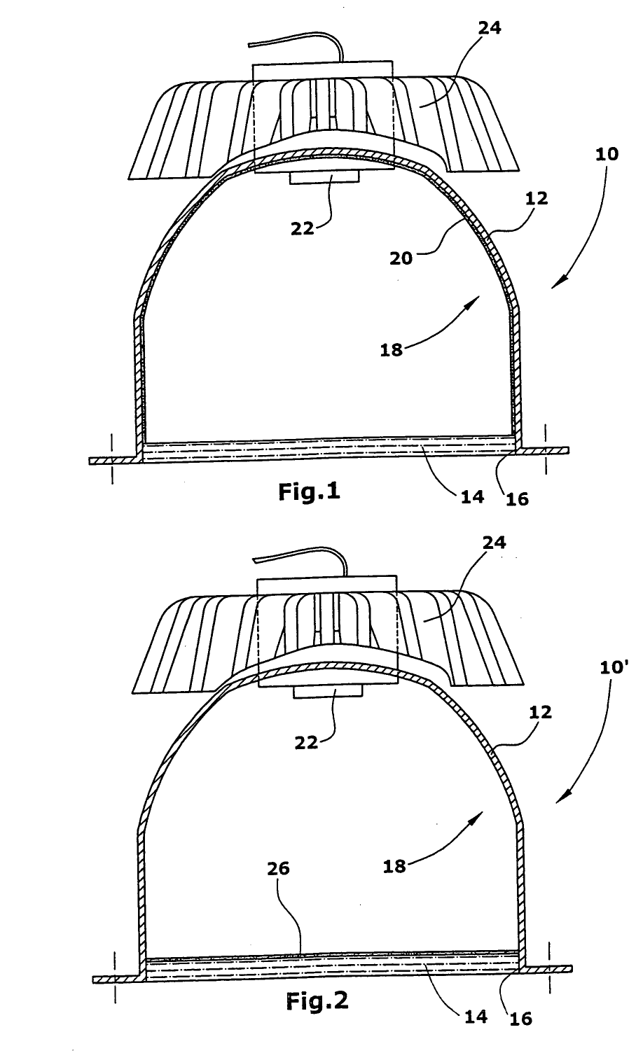

FIG. 1 illustrates a first embodiment of a reading light 10 in cross section, comprising a housing 12 with a light exit opening 16 closed by a light cover 14. The housing 12 is configured as a reflector 18 with a light absorbing or intensity reducing coating 20 thereon.

The illuminant of the reading light 10 is a LED or a LED module 22 (i.e. a plurality of LED chips on a common header) that emits white light in a wavelength range of about 400 nm to about 800 nm. The LED or the LED module 22 is cooled by means of a cooling body 24.

The coating 20 of the reflector 18 reduces the intensity of or absorbs the emitted white light within a wavelength range of about 400 nm to about 510 nm. Thus, light within this wavelength range will not exit from the light cover, provided it is reflected by the reflector 18. To be able to also filter the light from the LED or the LED module 22 exiting directly through the light cover 14, it is feasible to provide at least the center and the central portion of the light cover 14 with a corresponding coating

FIG. 2 illustrates an alternative embodiment of a reading light 10′ that also comprises a housing 12 with a light exit opening 16 closed by a light cover 14 the reading light 10′ also includes a LED or a LED module 22 (i.e. a plurality of LED chips on a common header), which emits white light. Further, the reading light 10′ also comprises a cooling body 24 for the LED or the LED module 22.

In contrast to the reading light 10 of FIG. 1, the reflector 18 is not provided with a coating absorbing light in a certain wavelength range, as described before in connection with the embodiment of FIG. 1. In the reading light 10′ of FIG. 2, such a coating 26 rather is a part of the light cover 14, the coating being applied on the inner surface of the light cover 14, for example. The coating 26 effects an absorption or reflection of light within the wavelength range from about 380 nm to about 500 nm.

Possible materials for the coatings 10 and 26 are dichroic materials or color materials. These materials absorb (reduction of intensity) or reflect light within certain wavelength ranges, i.e. they are transparent for other wavelength ranges.

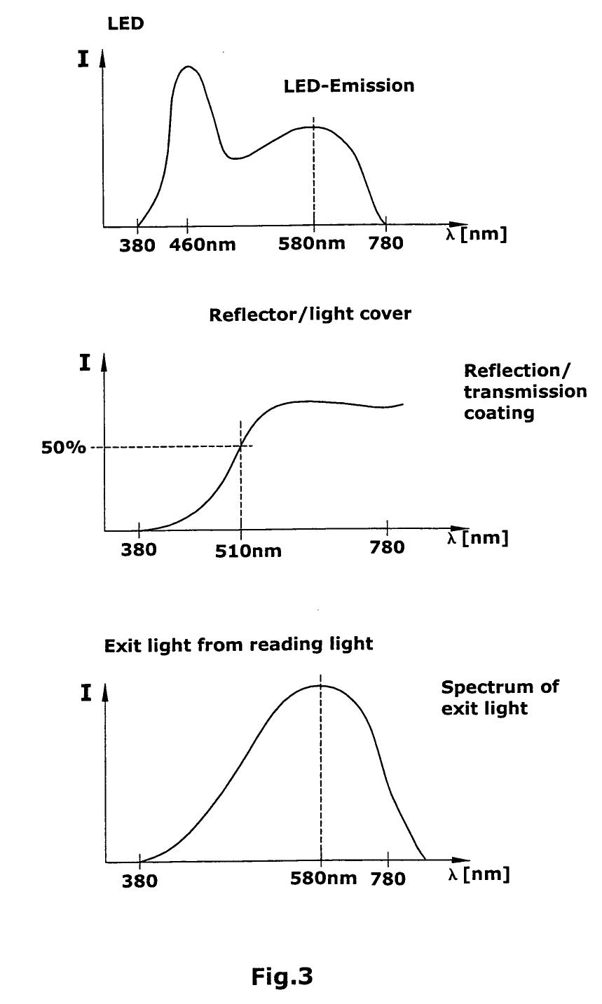

FIG. 3 illustrates the graphs of the light emission (intensity vs. wavelength) of the LED or the LED module 22, the reflectivity or transparency of the coating 20, 26 and the resulting spectrum of the light emitted.

Although the invention has been described and explained with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

What is claimed is:

1. A reading light for a vehicle, in particular for fitting above a vehicle seat of a vehicle, such as an airplane, comprising
at least one LED emitting white light, and
a reflector and/or a light cover,
the reflector and/or the light cover being provided with a coating that absorbs or reduces the intensity of the light of the at least one LED whose wavelength is less than a predefinable wavelength value.

2. The reading light of claim 1, wherein the at least one LED emits light at least in the wavelength range between about 380 nm to about 780 nm, and wherein the coating absorbs or reduces the intensity of light in the wavelength range below about 500 nm.
